(19) United States
(12) Patent Application Publication
(10) Pub. No.: US 2005/0166220 A1
(43) Pub. Date: Jul. 28, 2005

(54) Visual Network Appliance System

(76) Inventor: Brent McKay, Newport Beach, CA (US)

Correspondence Address: BRENT MCKAY, 3901 WESTERLY PLACE #110, NEWPORT BEACH, CA, 92660, US

(21) Appl. No.: 10/907,553

(22) Filed: Apr. 5, 2005

Related U.S. Application Data
(63) Continuation-in-part of application No. 09/943,585, filed on Aug. 30, 2001.
(63) Continuation-in-part of application No. 10/004,281, filed on Oct. 31, 2001.
(63) Continuation-in-part of application No. 10/660,818, filed on Sep. 12, 2003.
(63) Continuation-in-part of application No. 11/012,055, filed on Dec. 13, 2004.
(60) Provisional application No. 60/559,441, filed on Apr. 6, 2004.

(51) Int. Cl. H04N 7/025

(52) U.S. Cl. 725/32

(57) ABSTRACT

A visual network appliance system includes display, processor, memory, data communications interface, and local operating system and software in a self-contained chassis, and is suitable for deployment as an unattended remotely-managed information or entertainment device.

### PRIORITY CLAIM

This patent application claims the benefit of the filing date of the U.S. Provisional Patent Application Ser. No. 60/559,441, filed Apr. 6, 2004 and entitled VISUAL NETWORK APPLIANCE SYSYTEM, the entire contents of which are hereby expressly incorporated by reference. In addition, the present application is a continuation-in-part application of and claims priority under 35 U.S.C. sctn. 120 on U.S. patent application Ser. No. 09/943,585 filed Aug. 30, 2001, U.S. patent application Ser. No. 10/004,281 filed Oct. 31, 2001, U.S. patent application Ser. No. 10/660,818 filed Sep. 12, 2003, and on U.S. patent application Ser. No. 11/012,055 filed Dec. 13, 2004. Each of these four prior applications is incorporated herein by reference.

### FIELD OF THE INVENTION

This invention relates to a new class of display systems referred to herein as “Visual Network Appliances” or “VNA” systems and, in particular, to highly integrated, self-contained and secure display systems suitable for long-term continuous unattended operation with automated monitoring and sophisticated remote management capabilities.

### DESCRIPTION OF THE PRIOR ART

The terms “Network Appliance” and “Internet Appliance” have been used to describe a class of electronic devices which run autonomously without much if any human intervention while being managed and/or monitored over a network of some kind. Typically these devices have embedded computers with an Ethernet network interface, are connected to the Internet, are IP-addressable, and are managed or communicate regularly with remote computers. The Network Appliance usually operates as a dedicated single-purpose machine or as a limited-functionality general-purpose machine that serves as a gateway to remote services and information. In the context of a home, a heating control system which was configured as a network appliance could be controlled by the owner's computer at work; in a commercial building any number of facility operation monitoring and control systems could be monitored and managed remotely by utilizing Network Appliance architectures.

With respect to large-format fixed-location electronic display systems, the display component has traditionally been designed as an external monitor to a computer or video source rather than in a more integrated fashion. As a result, these systems often require extensive IT resources local to the facility in order to install, configure, and maintain proper operating condition. Although the computer running these monitors could be configured as a Network Appliance, decoupling the display from the computer in this way results in an intelligent, network-connected Network Appliance control system sending data to a “dumb,” network-isolated display system.

A good example of this traditional design strategy representative in the art of the time was the first generation of large-format plasma display systems first introduced to the US market in the mid-1990s, which were configured as consumer display monitors and optimized for video applications. Even today, this architecture still dominates within the plasma display industry.

The first known prior art of a large-format display system architected as a Network Appliance was developed by Interactive Media Network under license from the present inventor's assignee. The system was developed in 1999 and described in the currently pending patent application number 20020078459. The WayFinder42 product was optimized as a special-purpose digital signage system for use in commercial property applications.

The WayFinder42 (and in general the new class of display system it represents, subsequently called “Visual Network Appliances” or “VNA”) addressed a number of deficiencies in the prior art, including more efficient and flexible installation capabilities, reduced service and maintenance costs, improved reliability, and more efficient management. These improvements were largely a result of applying the principles of Network Appliance design to this new application: a strategy which, at the time, ran counter to the rest of the industry's design philosophy.

Although the WayFinder42 represented a substantial improvement over prior art, there are a number of improvements which the present inventor identified since the completion of the first-generation design; these improvements are the subject of the present patent application.

Enclosure system: The weight of the current generation of plasma display components is such that a VNA system built with them weighs about 70 pounds and cannot be readily removed from or mounted to its wall bracket by one person. The prior art enclosure designs do not facilitate servicing of the internal components while the system is mounted on the wall, thereby requiring removal of the entire system (by two technicians) when service is required. The present invention addresses the deficiencies in the prior art by allowing a single service technician to access most of the lowest MTBF (Mean Time Between Failure) components without requiring the removal of the entire system from the wall bracket, thereby cutting service call costs dramatically.

An additional aspect of enclosure system designs representative of the prior art is that the touch sensor element is mounted outside the primary enclosure, and connected electronically to the system's computer by a serial cable (or other industry-standard I/O cable). This ultimately means that the touch sensor housing becomes the dominant visible aspect of the entire system, and (except for the WayFinder42) causes the interface wire to be readily accessible to users (introducing a potential failure mechanism from tampering). The present invention addresses the deficiencies in the prior art by embedding the touch sensor electronics in the primary enclosure which eliminates external access to its interface wires and facilitates the use of the existing front bezel component to achieve the desired visual aesthetics of the system.

Enclosure system designs representative of the prior art also suffer from a weak security system for restricting unauthorized removal of the system, wherein removing screws which are readily accessible (even if they are the “security screw” type) will allow for removal of the system from the wall bracket. In addition, the I/O terminals are generally accessible in prior art implementations (except for the WayFinder42) and therefore introduce a potential tampering or content security issue. The present invention addresses these deficiencies in the prior art by utilizing a key locking mechanism as the mounting and I/O access point in conjunction with an actuation sensor which can then be used for security alert purposes.

Another aspect of enclosure system designs representative of the prior art is that they do not accommodate the electrical and data receptacles to be located behind the active area of the display while still allowing for accessibility to the plug and receptacle after the display enclosure is mounted to the wall bracket. The present invention addresses these deficiencies in the prior art by incorporating a receptacle access cavity behind the active area of the display surface which allows access to the plugs and receptacles while an ADA-compliant enclosure is mounted to the wall, limits access to the receptacles through the security key, and thereby eliminates the need for using an over-sized bezel to cover the receptacles or to use extension cables with remote receptacle locations.

Mounting System: in order to achieve an ADA-compliant wall-mounted system without creating a cavity in the wall itself, the WayFinder42 modified the cooling design representative of the prior art to allow for zero clearance (or near-zero clearance) between the system enclosure and the wall; other plasma display systems had airflow vents on the back side of the enclosure and required an air gap between the wall and the enclosure for proper thermal operation. In fact, the mounting system used for these products typically added two to three inches of protrusion, and with a four-inch maximum required for ADA-compliance, this proved to be an unacceptable design constraint.

In order for the mounting system of the WayFinder42 to accommodate near-zero clearance while at the same time achieve earthquake safety requirements imposed by the Universal Building Code (“UBC”), a full-size mounting bracket was used which extended to the base of the enclosure and incorporated a lock-down screw to keep the system enclosure from being lifted off of the mounting bracket (or bouncing off during an earthquake). This full-size mounting bracket design increased the weight and cost of the mounting system and required that the bracket extend to the base of the enclosure, thereby exposing the lock-down screws to users or requiring an oversized bezel to cover them.

The present invention addresses these deficiencies in the prior art by utilizing mounting designs which substantially reduces weight and cost while facilitating a secure, UBC-compliant installation, as well as a completely flush mounted configuration.

Thermal System: Thermal systems representative of the prior art are based on normal airflow or fan-accelerated airflow, and with the exception of the WayFinder42 include air vents on the back of the main enclosure. While the WayFinder42's thermal system allowed for a significant reduction in the distance that the system protruded from the surface containing the mounting bracket, it was still an “open” thermal design and therefore allowed airborne particles to enter the enclosure. While in some environments the effect of this fact on reliability is insignificant, in other environments such as those near commercial kitchens, the airborne particles and grease could cause premature failure of the system. Additionally, in most environments the airborne particles will accumulate over time on the surfaces of the display and optical filter and reduce the luminosity of the display. Finally, none of the prior art enclosure and thermal design implementations facilitates NEMA ratings suitable for exterior installations, moist environments, or reduced susceptibility to moisture-related vandalism (e.g., pouring a soda in the air vents).

In one embodiment of the present invention, these deficiencies in prior art are addressed through the use of a hermetic enclosure with a conductive thermal system.

PDP Interface: The primary application for the WayFinder42 was in an interactive mode whereby users would be in close proximity to the display surface while they accessed information using the infrared touch panel. As a result, the image quality needed to be good when viewed at close range, which was generally not the case with large-format plasma displays representative of the art. The problem with the art was twofold: large pixel size in combination with image distortions introduced by the video scaling circuitry. The resulting “fuzzy” edges of text and small details were distracting at close range (although generally not too problematic when viewed at a distance). The WayFinder42 addressed the deficiencies in prior art by utilizing an digital pass-through interface architecture, thereby eliminating the image distortion problem introduced by the scaling engine and improving readability of the display at close range.

While the WayFinder42's digital pass-through interface solved the close-proximity readability problem, it did not lend itself to support resolutions and video aspect ratios which did not match the PDP's native resolution.

The present invention addresses these deficiencies in the prior art by utilizing a combination digital pass-through and video scaling architecture for the image data stream.

### SUMMARY OF THE INVENTION

It is an object of the present invention to provide a Visual Network Appliance design that overcomes many of the disadvantages of prior art arrangements.

It is another object of the present invention to provide a Visual Network Appliance design for which most common repairs can be serviced by a single technician.

It is another object of the present invention to provide a system which can be converted to a Visual Network Appliance by adding a closely coupled processing unit which does not require an increase in the outside dimensions of the system in order to accommodate it.

It is another object of the present invention to provide a system which is highly optimized towards IP-only (digital data) environments, while facilitating adding analog video support as an option.

It is another object of the present invention to provide a mounting system for a large-format display system which facilitates flush mounting to the wall or stand.

It is another object of the present invention to provide an integrated security system for large-format displays which can be used to minimize theft or unauthorized access to the systems I/O or cables.

It is another object of the present invention to provide a large-format display system design for which the finish of the bezel component can be cost effectively modified to facilitate low-cost customization of the dominant visual aspect of the system.

It is another object of the present invention to provide a large-format display system design that facilitates location of power and data communications receptacles behind the system when mounted flush to the wall or stand (“zero clearance”) without requiring an increase in the height or width of the system to cover the receptacles.

It is another object of the present invention to provide a large-format display system design that utilizes a hermetic enclosure and conductive thermal design to facilitate use in moist or dirty air environments.

### BRIEF DESCRIPTION OF THE DRAWING

FIG. 1 is a block diagram of a system according to traditional architecture of prior art.

FIG. 2 is a block diagram of a system according to one embodiment of the present invention, showing the basic structure of a Visual Network Appliance (“VNA”) system.

FIG. 3 is a block diagram of a first-generation VNA system, showing the basic mechanical construction.

FIG. 4 is a block diagram of a system according to one embodiment of the present invention, showing a cross section of the housing and component bay features.

FIG. 5 is a block diagram of a system according to another embodiment of the present invention, showing a cross section of the touch electronics features.

FIG. 6 is a block diagram of traditional large-format display system case structure.

FIG. 7 is a block diagram of a system according to one embodiment of the present invention, showing the general location and structure of the mounting brackets.

FIG. 8 is a block diagram of a system according to one embodiment of the present invention, showing a more detail of the mounting bracket features.

FIG. 9 is a block diagram of a system according to one embodiment of the present invention, showing a cross section of the housing and external component bay features.

FIG. 10 is a block diagram of a system according to one embodiment of the present invention, showing the general location and structure of the Security Collar feature.

FIG. 11 is a block diagram of a system according to one embodiment of the present invention, showing more details of the Security Collar feature.

FIG. 12 is a block diagram of a system according to one embodiment of the present invention, showing the general location and structure of the secure receptacle and cabling feature.

FIG. 13 is a block diagram of a system according to one embodiment of the present invention, showing the general structure of a remote monitoring system.

FIG. 14 is a block diagram of a system according to another embodiment of the present invention, showing an enhanced remote monitoring system which facilitates control of the main processor during the initial boot sequence.

FIG. 15 is block diagram of a system according to another embodiment of the present invention, showing an enhanced remote monitoring system which facilitates power reset of the main processor even during OS lockup conditions.

FIG. 16 is a block diagram of typical content security architectures for Digital Signage systems representative of prior art arrangements.

FIG. 17 is a block diagram of a system according to one embodiment of the present invention, showing modified content security architectures for Digital Signage systems.

FIG. 18 is a block diagram showing the types of files used in the typical Digital Signage system.

FIG. 19 is a block diagram of a system according to another preferred embodiment of the present invention, showing modified content security architectures for Digital Signage systems.

### DETAILED DESCRIPTION OF THE PREFERRED EMBODIMENT

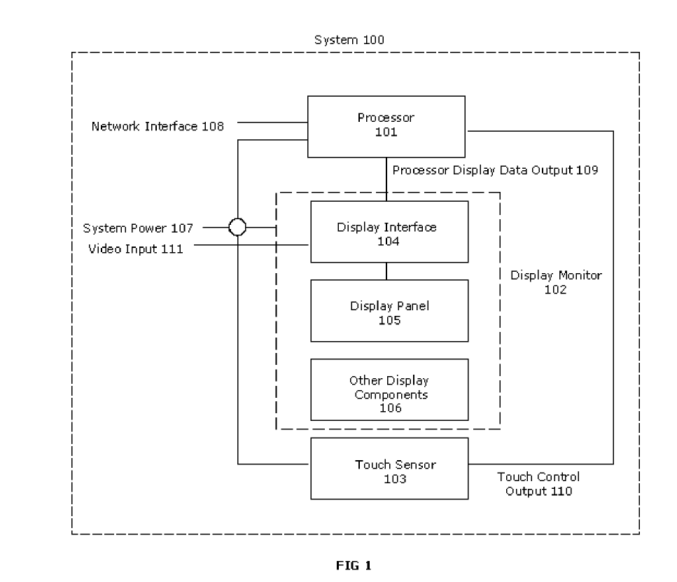

FIG. 1 illustrates a System 100 showing an interactive digital signage system according to traditional architecture representative of most prior art (see Exhibit 0 plasma monitor and touch sensor specifications). The System 100 is comprised of a Processor 101, Display Monitor 102, and Touch Sensor 103. Each of these three main components is a separate, self-contained system which is individually FCC and safety certified, and in general sold by different manufacturers. In this architecture, each of the three components typically has separate System Power 107 inputs and all three are usually embedded within a larger enclosure of some kind when deployed as a digital sign in a commercial facility. The Processor 101 generally serves as the primary Network Interface 108, receiving content and control information from a remote server of some kind. In one version of this architecture, all display image data is sent to the Display Monitor 102 by the Processor 101 through the Processor Display Data Output 109 connection, which could be of an analog RBG type, digital DVI, or some other protocol. In another version of this general architecture, the Display Monitor 102 receives the display image content through the Video Input 111, which is some kind of analog video signal like NTSC.

Referring again to FIG. 1, the Display Monitor 102 is comprised of a Display Interface 104, Display Panel 105, and Other Display Components 106. In all known prior art configurations, the Display Interface 104 is a video scaling board which converts the analog Video Input 111 data to the native digital input format of the Display Panel 105 (which is typically an LVDS-type interface). The Processor Display Data Output 109 signal is also directed into this same Display Interface 104 board for conversion. Because of the wide range of video input standards and RGB resolutions that need to be supported, and because of the peculiarities introduced as a result of the conversion between analog video inputs an the digital plasma display, the Display Interface 105 represents a significant cost point for the overall system, often the number two cost point behind the Display Panel component.

As indicated previously, the traditional System 100 architecture results in numerous deficiencies in prior art which the current invention addresses.

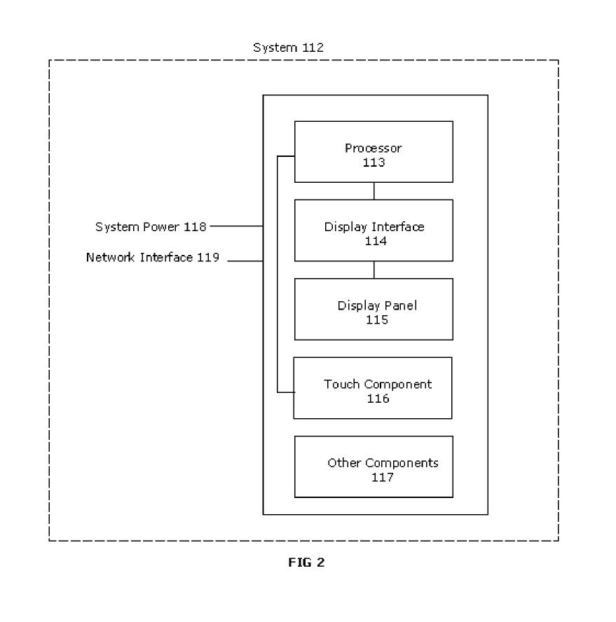

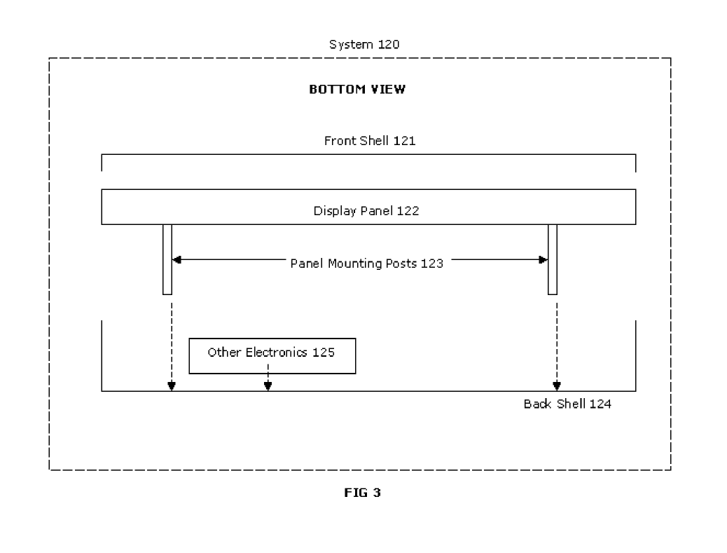

FIG. 2 illustrates the structure of the interactive Visual Network Appliance (“VNA”) architecture first described in the present inventor's currently pending patent application number 20020078459 (and the WayFinder42 which was its first commercial implementation by Interactive Media Network) wherein the main components shown in FIG. 1 (Processor 101, Display Monitor 102, and Touch Sensor 103) are integrated into a single system, forming the basic structure of an interactive VNA. This System 112 has a single System Power 118 input and is FCC and safety certified as a stand-alone unit.

Referring again to FIG. 2, the Processor 113, Display Interface 114, Display Panel 115, Touch Component 116 and Other Components 117 are more tightly coupled within the system, eliminating redundant components required in the System 100 architecture and facilitating a number of improvements as outlined later in this application and other previous related applications of the present inventor.

Although the higher level of integration represented by System 112 (FIG. 2) naturally lends itself to improved system reliability and therefore lower service costs, the original implementation by Interactive Media Network (the WayFinder42) was designed in such a way that when servicing was necessary it required two technicians to accomplish the task. This was because the entire system needed to be removed from the wall mounting bracket in order to service almost all of the components, which required two people to accomplish because of the weight of the system. Not only did this double the cost of the service call, it required a certain level of physical capability not normally required by computer technicians, introduced the possibility for damage to the fragile glass of the PDP module, required opening up the system case and exposing all of the electronics to additional damage, and required more extensive training of the technicians in order to properly service the unit.

FIG. 3 illustrates the basic mechanical design of the WayFinder42 system, shown as a cross section (when viewed from the bottom of the system). The System 120 employs a basic two-piece mechanical construction, with an aluminum Front Shell 121 and aluminum Back Shell 124 encasing the Display Panel 122 and Other Electronics 125. The Display Panel 122 is attached to the Back Shell 124 via Panel Mounting Posts 123; the Other Electronics 125 are also mounted to the Back Shell 124 and occupy the space between the Display Panel 122 and the Back Shell 124.

Servicing System 120 required 1) removing the System 120 from the wall mounting bracket, 2) laying the system on the Back Shell 124, 3) removing the Front Shell 122 attachment screws, 4) lifting off the Front Shell 122, 5) flipping the remaining system over so that it rested on the Display Panel 122, 6) removing the attachment screws securing the Panel Mounting Posts 123 to the Back Shell 124, 7) removing several cable assemblies, and 8) removing the Back Shell 124 from the Display Panel 122. At this point, the service technician(s) would have access to the internal components for repair/replacement.

The basic mechanical design outlined in FIG. 3 is representative of the WayFinder42 as well as all known prior art in the field of Visual Network Appliances and large-format Display Monitors, and in general does not lend itself to economical field serviceability. Furthermore, because of the weight and fragile nature of plasma displays, shipping systems to a central repair depot is also costly and very problematic in terms of a high percentage of Display Module breakage during packing and shipping (which renders the system as a complete loss because of the fact that the Display Module represents such a large percentage of the overall cost of the system).

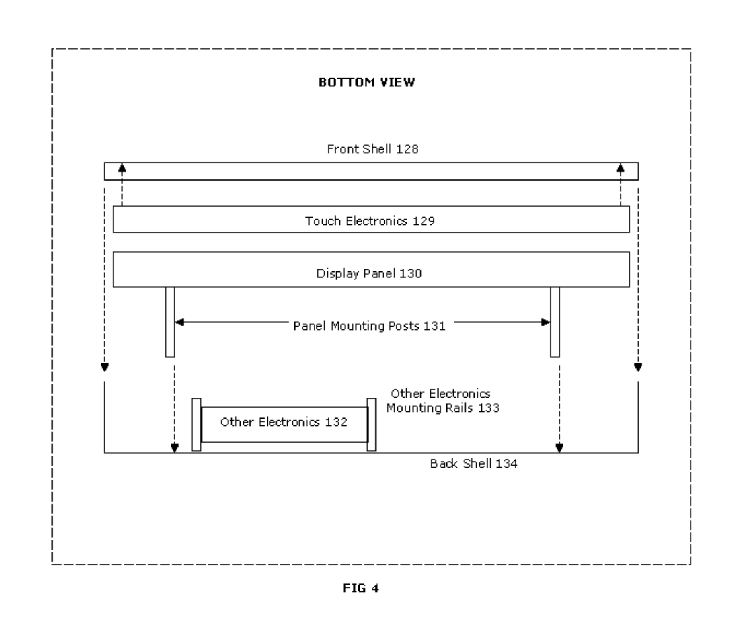

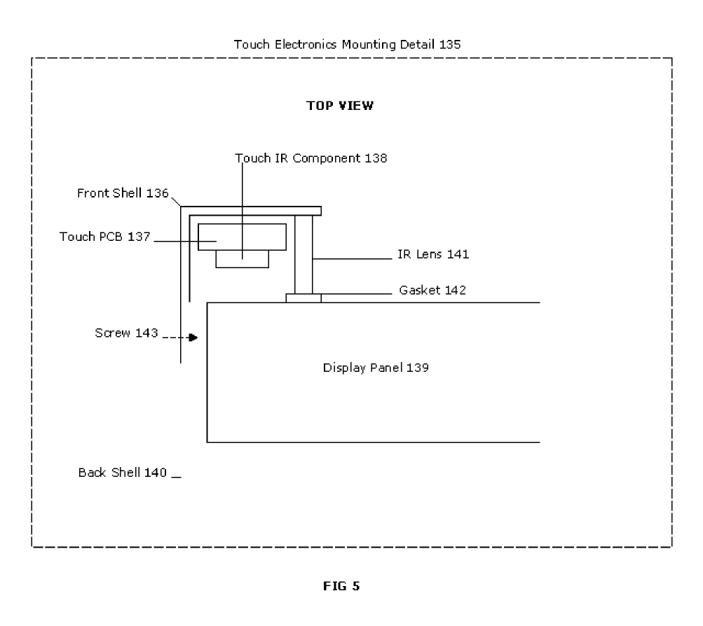

FIG. 4 illustrates one embodiment of the present invention whereby the Other Electronics 132 (display interface, processor, hard drive, etc.) are slid into component bays onto the Other Electronics Mounting Rails 133 from the bottom of the System 126 (or alternately, from the top or sides); the Other Electronics Mounting Rails 133 are in turn mounted to the Bach Shell 134 along with the Display Panel 130. This design facilitates removal and replacement of these Other Electronics 132 components without removing the entire System 126 from the wall or stand.

Referring again to FIG. 4, the Touch Electronics 129 is sandwiched between the Front Shell 128 and the Display Panel 130. Since the Display Panel 130 is suspended entirely from the Back Shell 134, which is in turn mounted to the wall or stand through its associated mounting system, this also facilitates removing and replacing the Touch Electronics 129 without removing the heavy and fragile Display Panel 130 from the wall or stand. In one preferred embodiment of the present invention, the Touch Electronics 129 are a low-profile infrared type in which the PCB or other electronics mounting substrate is attached to the Front Shell 128 and the wiring harness is connectorized in order to facilitate easy disconnection and removal of the Front Shell 128 and Touch Electronics 129 for servicing.

Although there exists some examples of relevant prior art wherein component bays are used for adding inputs to a plasma monitor system (like the Panasonic specification shown in Exhibit 0), there are no known examples of prior art wherein component bays are used for all of the significant components outside of the Display Panel, thereby facilitating single-technician servicing for the majority of the non-Display Panel failures. Because a large percentage of field failures are not related to the Display Panel, this represents a significant deficiency in the prior art arrangements.

Furthermore, there are no known examples of prior art wherein the component bay is used for integrating processor, hard drive, or other VNA-related architectural components. The closest known example is the NEC 42VP4 plasma monitor which has a cavity in the back of the monitor with mounting holes designed to accommodate a low-profile standalone PC like the Mitak Industries (see Exhibit 0 for NEC and Mitak specifications. However, this configuration does not facilitate flush mount or ADA compliant mounting, and is not a component bay (but rather simply an indentation in the back shell of the monitor.

The present invention addresses these deficiencies in the prior art by creating a system that allows a single service technician to access most of the system components without requiring the removal of the system from the wall bracket, thereby cutting service costs dramatically. Furthermore, the present invention addresses deficiencies in the prior art by integrating the Processor into the system to create a VNA-based architecture while still facilitating modular removal and replacement without removing the system from the wall mounting bracket (or increasing the outside dimensions of the system enclosure).

To draw the distinction between the prior art in large-format display systems and this present invention more clearly, the present invention utilizes component bays for the primary electronic components (with the exception of the Display Panel 115, which is supported by the back shell of the housing and mounting system, and requires removal of the entire system from the mounting bracket to service), in combination with front access to the Touch Component 116 and other components not suitable for locating in the component bays.

The present invention is therefore novel in its application of system design technology, and unique in its capabilities, in that it addresses the stated deficiencies in the prior art.

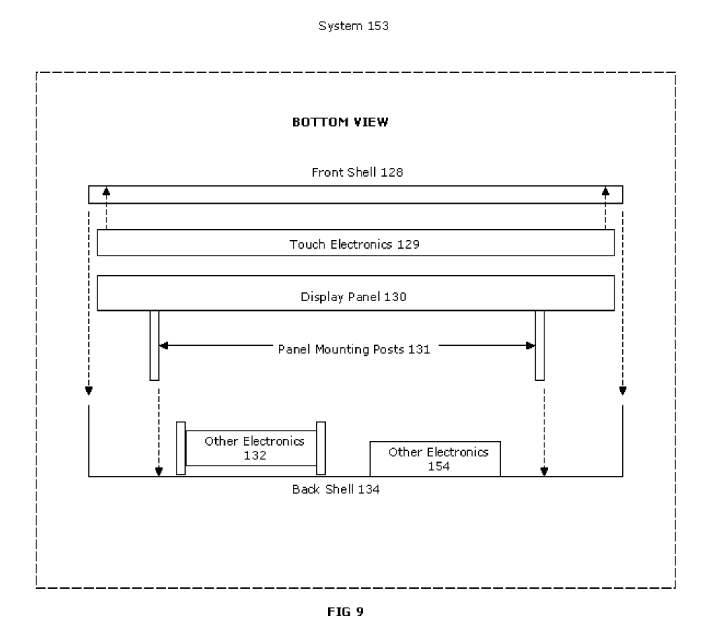

FIG. 9 illustrates a modified version of System 126 shown in FIG. 4, wherein Other Electronics 154 is housed external to the primary system enclosure. These Other Electronics 154 are located in the same general location as the Other Electronics 132 component bays are (meaning, behind the Display Panel 130 and near the outside perimeter of the Back Shell 134 housing such that the exterior face is flush (or nearly flush) with the side face of the Back Shell 134. This version of the system design facilitates including processor and system options which do not form a part of the primary system enclosure and therefore can be individually tested and certified. This strategy is more advantageous for certain product components which are sold as options to the base system, as opposed to primary system components which would be used in most or all of the applications.

The present invention addresses the deficiencies in the prior art by facilitating Processor to be added to the system without adding to the outside dimensions of the system enclosure.

To draw the distinction between the prior art in large-format display systems and this present invention more clearly, the present invention addresses deficiencies in the prior art by integrating the Processor into the system to create a VNA-based architecture while still facilitating modular removal and replacement without removing the system from the wall mounting bracket (or increasing the outside dimensions of the system enclosure), while at the same time facilitating stand-alone certification of the processing unit.

The present invention is therefore novel in its application of system design technology, and unique in its capabilities, in that it addresses the stated deficiencies in the prior art.

One of the disadvantages of the System 100 traditional design (FIG. 1) is that the Display Interface 104 component must include analog scaling and conversion circuitry, thereby increasing the cost of the system unnecessarily for those applications in which only digital-type data is used at the Processor Display Data Output 109 interface. Because the Display Monitor 102 was designed primarily for consumer video applications, the percentage of applications in which this was the case was negligible. However, in commercial Digital Signage applications, the trend is clearly towards IP-based content wherein the Video Input 111 is not used, and the video scaling and analog conversion circuitry is not required. For this class of applications, there exists an opportunity to bring an IP-Only VNA (“IP-VNA”) system or a Video-Optional (“VO-VNA”) to market which services this application without the added cost of unused video features.

To date, manufacturers of Display Monitors 102 have not introduced “digital data only” versions of their systems because only a small subset of off-the-shelf Processor 101 systems have digital outputs suitable for driving this kind of modified Display Monitor 102, because the systems would lose the flexibility to be driven by video sources, and because of the cost and complexities required to support the drivers and configuration issues with all of the disparate off-the-shelf Processor 101 systems on the market.

In spite of these drawbacks, there exists a significant market need to provide a system that is optimized for digital data-only environments. McKay's application number 20020078459 represented the first known prior art disclosure of such a “video-less” system architecture, whether the display system was configured as a VNA or an interactive VNA (“iVNA”).

In another preferred embodiment of the present invention, the System 153 design strategy is used (FIG.9), the Processor unit is configured as an Other Electronics 154 component (also FIG. 9), and no analog data or video inputs to the system are provided (a digital input from the Processing unit is the only means for delivering data to the Display Panel for display). This architecture is in fact a “video-less” display monitor which overcomes the aforementioned deficiencies ion the prior art. Adding a processing unit (as an Other Electronics 132 or Other Electronics 154 component) efficiently converts the system to an IP-VNA.

Furthermore, providing an Other Electronics 154 option which allows for the video inputs to be supported in turn converts the system to a VO-VNA system.

The present invention addresses the deficiencies in the prior art by facilitating a low-cost system highly optimized for IP-only environments, while at the same time facilitating analog input support as an option.

To draw the distinction between the prior art in large-format display systems and this present invention more clearly, the present invention addresses deficiencies in the prior art by providing a base system which only supports digital input while converting the expensive analog support circuitry to an optional add-in component of the system. This is in strong contrast to prior art arrangements which all include video inputs and may or may not include digital inputs at all.

The present invention is therefore novel in its application of system design technology, and unique in its capabilities, in that it addresses the stated deficiencies in the prior art.

In another preferred embodiment of the present invention, the Touch Electronics 129 and Front Shell 128 are designed such that the Touch Electronics 129 can be removed from (or not included in) the System 126 and the same Front Shell 128 can be reinstalled without compromising the mechanical or electrical integrity of the system. In this way, the System 126 can be offered in interactive or non-interactive versions by simply adding or removing the electronics mounting substrates which are attached to the Front Shell 128. The specific design can take various forms to accomplish this end; one method is as shown in FIG. 5.

Referring to FIG. 5, the Touch Electronics Mounting Detail 135 shows a (not to scale) cross section of the front corner of the System 126 (FIG. 4). The Front Shell 136 (which has a cut-out corresponding to the active pixel area of the Display Panel 139) is attached to the Back Shell 140, which is formed to mate to provide a flush surface on the outside of the two pieces; these two shells are then attached by Screw 143 and other similarly positioned screws around the entire perimeter. The Touch Electronics 129 (FIG. 4) is comprised of a Touch PCB 137 substrate on which Touch IR Component 138 transmitter and receivers are mounted. This Touch Electronics 129 assembly is then attached to the Front Shell 136 and its associated wiring is connected as explained previously. The IR Lens 141 is an IR-transparent glass or plastic piece which is fit around the perimeter of the Front Shell 136 cutout, and serves to hide the IR electronics and protect them from damage. The IR Lens 141 is attached to the Front Shell 136 on the one side, and when the Front Shell 136 is mounted onto the Back Shell 140, the mechanicals are designed such that IR Lens 141 contacts the Gasket 142 with sufficient pressure to form a water tight seal against the Display Panel 139 glass face.

Referring again to FIG. 5, the Touch Electronics Mounting Detail 135 illustrates a design which includes the Touch Electronics 129 assembly to support interactive use. At the same time, eliminating the Touch Electronics 129 assembly from the design while maintaining all other aspects facilitates a touch option manufacturing strategy with minimal changes to the manufacturing flow, or supports a simple field upgrade strategy. The impact on the system design would be nominal if low profile (surface mounted) Touch IR Components 138 and Touch PCB 137 are used, in that the offset of the Front Shell 136 from the front face of the Display Panel 139 could be as small as ⅛ inches to ¼ inches.

The present invention is particularly relevant in that all of the known prior art as it relates to large-format touch electronics (40 inches and above) are in the form of a full system overlay mechanical structures with control wiring designed to run external to the display enclosure to a remote Processor 101 (as shown in FIG. 1). This means that the touch sensor housing becomes the dominant visible aspect of the entire system, and also causes the interface wire to be readily accessible to users (introducing a potential failure mechanism from tampering). The present invention addresses the deficiencies in the prior art by embedding the touch sensor electronics into the primary system enclosure, eliminating external access to its interface wires and facilitating the use of a purely aesthetic Front Bezel 127 component which can be economically modified to change the visual aesthetics of the system.

Using the design strategy reflected in System 126, a VNA system can be ordered originally non-interactive and later be economically field upgraded to interactive, creating a strong selling point given the historical organic nature of interactivity in large-format display applications.

The present invention addresses the deficiencies in the prior art by facilitating a low-cost, secure, and flexible method for providing touch capability to the base system.

To draw the distinction between the prior art in touch sensors for large-format display systems and this present invention more clearly, the present invention addresses deficiencies in the prior art by integrating component-level touch electronics into the primary system enclosure, as opposed to adding another bezel structure containing the touch electronics over the primary system enclosure. Furthermore, the present invention accomplishes this while still facilitating field removal, replacement, or upgrade without requiring that the system be removed from the mounting bracket or requiring a multiple Front Shell 136 structures to be used to accommodate systems with or without the touch electronics.

The present invention is therefore novel in its application of system and touch electronics design technology, and unique in its capabilities, in that it addresses the stated deficiencies in the prior art.

Another deficiency of prior art arrangements in large-format display systems is that the mounting systems are large, heavy (increasing shipping costs), deep (limiting the system's ability to meet ADA compliance for total protrusion. Typical mounting brackets representative of prior art are shown in Exhibits B (Zenith) and C (Hitachi). These add two to three inches of protrusion and weigh 20 pounds or more.

The present invention overcomes these deficiencies in prior art arrangements by facilitating the system to be mounted flush to the wall with a low cost and light weight system.

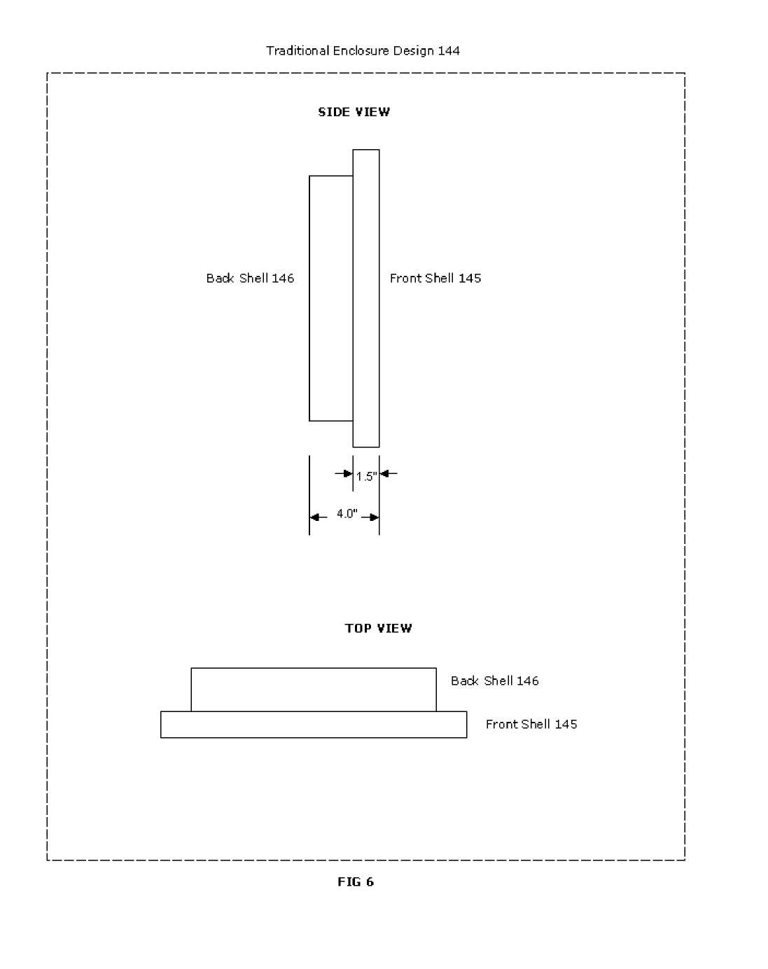

FIG. 6 illustrates the basic case structure of most plasma display monitors, wherein the Front Shell 145 is somewhat wider, taller, and narrower than the Back Shell 146. This is possible because of the typical structure of the Display Panel as shown in Exhibit A (NEC technical document 941-1H0038 showing the mechanical dimensions of its 42-inch PDP module), wherein the outside areas of the Display Panel are lower profile than the center area. In addition, plasma monitors typically have other components like the video scaling board located in the center area as well. This design strategy results in a system that appears thinner than it actually is, because the Back Shell 146 is not seen by the user except when the system is viewed at a severe angle.

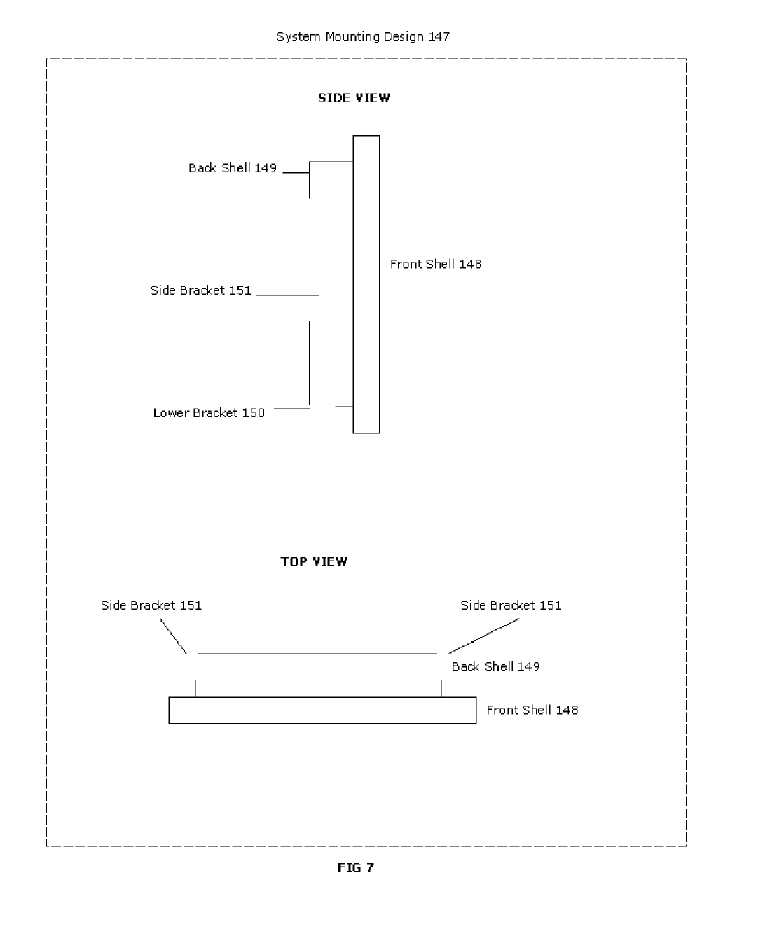

FIG. 7 illustrates the key design elements of the present mounting bracket invention. The mounting system is composed of three brackets, one Lower Bracket 150 and two Side Brackets 151.

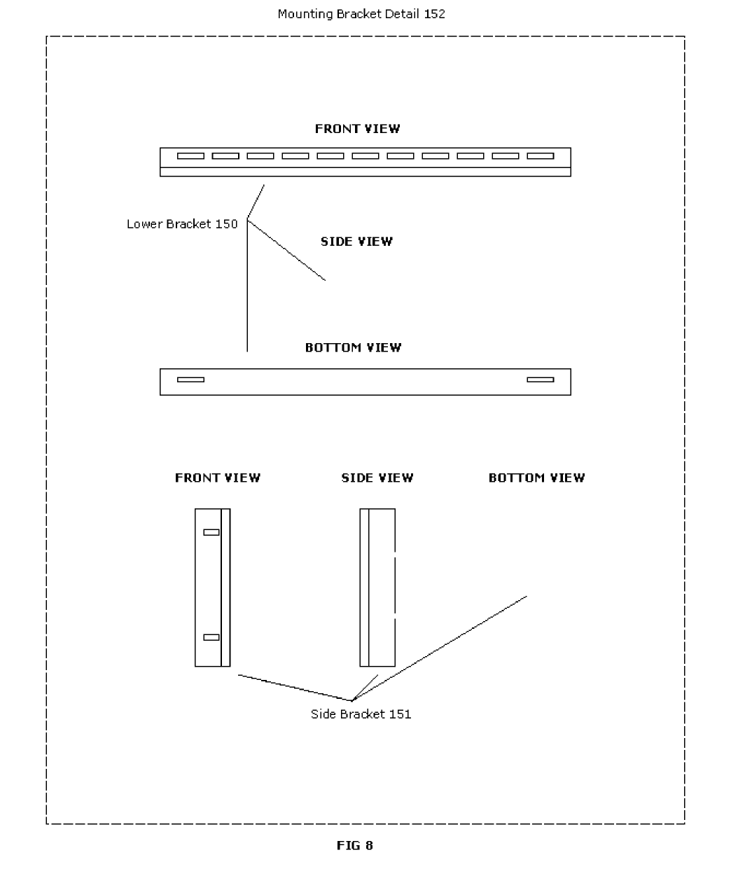

FIG. 8 illustrates more detail of the bracket designs. The Lower Bracket 150 is an L-shaped metal bracket which runs across the width of the Back Shell 149 and carries most of the system's vertical load. The bracket is attached to the wall by securing ICBO-certified screws or bolts through oblong or rectangular holes on the wall side of the Lower Bracket 150 into wall studs or other solid support members. The holes are dispersed along the entire length of the bracket so that proper alignment with the wall studs can be achieved, and are oblong or rectangular so as to allow for additional horizontal alignment. The bottom of the Lower Bracket 150 has two similar holes for lock-down machine screws which mate into threaded female screw receptacles on the bottom of the Back Shell 149. These screws are secured after the system is mounted onto the brackets so that it cannot be lifted off the bracket or bounce off during an earthquake.

Referring again to FIG. 8, the Side Bracket 152 is also an L-shaped metal bracket (see FRONT VEW). The wall side of the bracket has oblong or rectangular holes for the wall mounting fasteners. Since the side brackets have limited horizontal alignment capability, it is assumed that these fasteners will not make contact with the vertical studs, and as such will not carry much of the vertical load of the system. The SIDE VIEW illustrates the slotted design which will accept corresponding machine screws located on the sides of the Back Shell 149 and drop down into place once the system is pushed flush to the wall (at which point the machine screws are tightened. The vertical slots are designed to protrude lower than required so that the system will rest on the Lower Bracket 150 even if the Side Brackets 151 are installed slightly higher than specified.

In addition, an alternate set of similar mounting brackets could be designed to facilitate a portrait orientation of the system.

As indicated previously, prior art mounting systems for plasma and other large-format display systems were heavy and protruded out from the wall so far that achieving ADA compliance was difficult or impossible. The WayFinder42 was the first known implementation which eliminated air vents in the back of the system, allowing for a nearly flush mounting system to be used. Exhibit D illustrates the mounting bracket design for the WayFinder42, which yielded a total system protrusion of 0.12 inches from the wall.

The present invention addresses the stated deficiencies in the prior art and facilitates a low weight, low cost, completely flush mounting system while still hiding the bracket behind the Front Shell 148 (or in general, the front face of the display system), and without requiring an increase in the Front Shell 148 dimensions to do so. In addition, the width of the Side Brackets 150 can be made relatively small, which has additional advantages with respect to the design of the security collar (which will be outlined later in this application).

To draw the distinction between the prior art in large-format display systems and this present invention more clearly, the present invention is focused specifically on achieving a flush mounting capability which is significant in this application because of ADA compliance requirements and for additional thermal reasons which will be outlined later in this application.

The present invention is therefore novel in its application of mounting technology, and unique in its capabilities, in that it addresses the stated deficiencies in the prior art.

Another deficiency of large-format display monitors representative of prior art arrangements is that they include little if any security measures to prevent unauthorized removal of the system, and allow complete access to control switches, I/O ports, and various cables. Unlike consumer applications (which most of these systems were designed for), most Digital Signage and other commercial applications require additional security because the systems are deployed in unattended locations within reach of the public. In the past, achieving even modest levels of security in these applications required embedding all of the components in a larger stand or enclosure of some kind, which added significant costs and often place unacceptable limitations on the location and design of the installation. In addition, most Digital Signage applications are especially sensitive to displaying unauthorized content because of the public locations that they are located at; from this perspective, any access point into the system represents an opportunity to beach for someone with the interest in doing so.

The present invention overcomes these deficiencies in prior art arrangements by utilizing an integrated, lockable mounting collar which restricts access of I/O ports, cables, and mounting screws to authorized personnel only. Further security is achieved by the use of activation sensors and embedded content security software and hardware.

The simplest way to cover all mounting screws and I/O terminals is with a full-size bezel similar to the WayFinder4250, which mounts onto the core VNA system and extends all the way to the wall or stand. Including a locking mechanism on this kind of bezel and tying the lock to an activation sensor which would send an electrical signal to the system processor when unlocked would meet the basic requirements and provide a significant improvement to the prior art.

However, in a preferred embodiment of the present invention the mounting design results in a lighter, less expensive and more visually appealing solution than using a full size bezel.

Referring again to FIG. 6, note that the overall case structure (which is defined here by the Front Shell 145 and Back Shell 146 components) which the present invention utilizes includes a larger (in terms of width and height) Front Shell 145 than the Back Shell 146. Furthermore, the previously described mounting system is positioned adjacent to the Back Shell 146 sides and below the Back Shell 145, and adds only slightly (¾ inches to one inch) to the outside dimensions of Back Shell 146 plus bracket combination (see FIG. 7). Note also that all of the mounting hardware, I/O ports, and external cables (to be described later) are contained within the perimeter of the Back Shell 146 component.

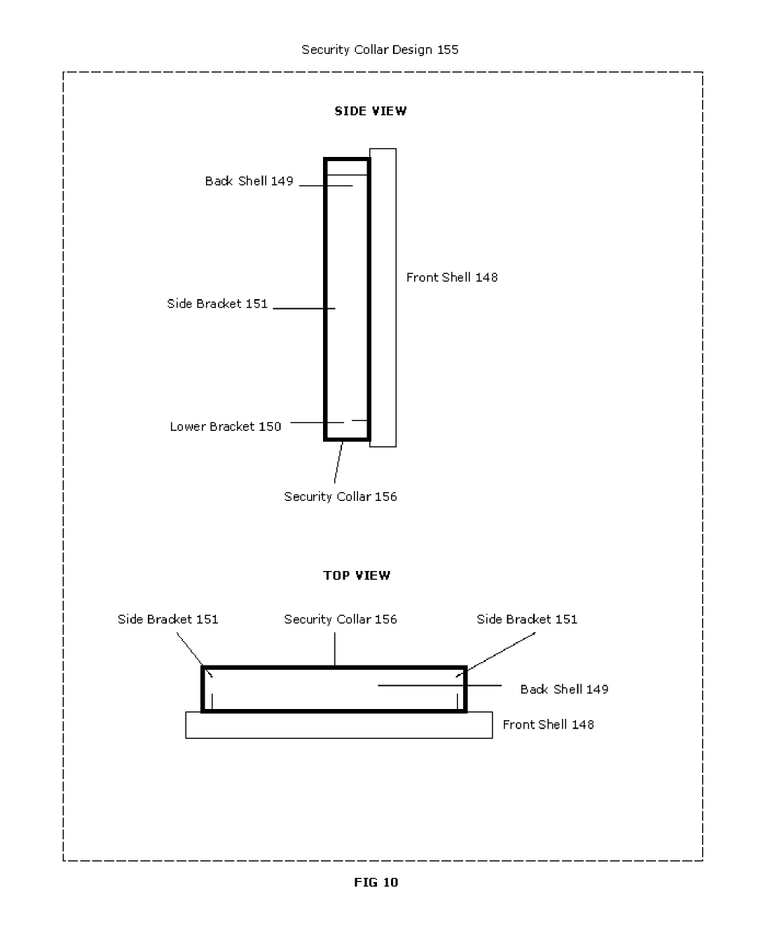

As shown in FIG. 10, the present invention utilizes a collar which encases the Back Shell 149 and mounting brackets without exceeding the height or width of the Front Shell 148, thereby keeping with the overall design strategy of the system as described previously. The material used could be any number of potential materials, but metal would be the most likely choice.

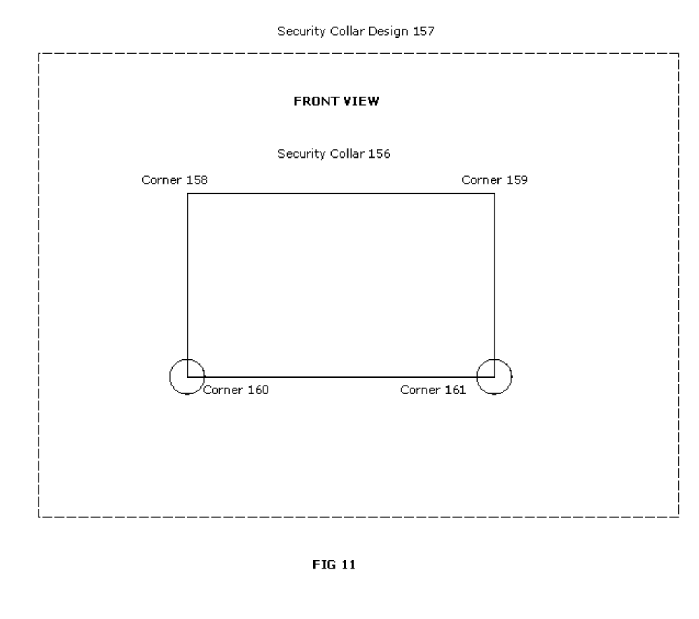

FIG. 11 illustrates additional detail about how the Security Collar 156 is designed. The corners identified as Corner 158 and Corner 159 could be fixed (such as an angle bend in the metal), hinged (to allow a full collapse for packing and shipping), or connected in some other way so that the two segments which form the corner can come apart during assembly and stay secure when installed. Corner 160 is hinged and Corner 161 can be unhooked, allowing the bottom section to swing down and the collar to be dropped down over the Back Shell 149 (FIG. 10). Once dropped down, the bottom section can be swung back up into position and re-attached at Corner 161. In a preferred embodiment of the invention, the Corner 161 includes a locking mechanism which limits access to authorized personnel. In a further preferred embodiment of the invention, the locking mechanism (or other element of the Security Collar 156) utilizes a sensor which notifies the processor when the lock has been opened.

The present invention addresses the stated deficiencies in the prior art and facilitates a low weight, low cost, compact security system for large-format display systems, which can be implemented without altering the primary aesthetics of the system. Furthermore, the invention allows for the inclusion of a sensor which can be used to electronically monitor when the Security Collar 156 has been opened, and therefore when the system's mounting hardware, I/O ports, and external cables are exposed.

To draw the distinction between the prior art in large-format display system security systems and the present invention more clearly, the present invention is focused specifically on achieving a secure mounting system without embedding the system in a larger enclosure of some kind, and furthermore integrating electronic sensor technologies which were previously not a part of prior art arrangements.

The present invention is therefore novel in its application of large-format display security technology, and unique in its capabilities, in that it addresses the stated deficiencies in the prior art.

Another deficiency of large-format display systems representative of prior art arrangements is that they do not readily accommodate modifying the finish of the front bezel or other dominant exterior element. In order to achieve some economies of scale and a streamlined manufacturing flow, the bezel material and finish is selected in advance and the one configuration is generally used for all of the systems shipped. In addition, the bezel mounting system is not usually designed for ease of removal in the field. The net result is that in prior art arrangements the systems do not lend themselves to modification of the finish, and therefore can not be easily customized to accommodate the facility's interior design scheme.

One method to achieve a measure of improvement of the prior art would be to design the Front Shell 136 mounting system shown in FIG. 5 so that it could be readily removed in the field (which is described previously for other reasons), it could then be replaced with another one with a different finish. However, this strategy would require that the large Front Shell 136 component be manufactured in multiple finishes, increasing the cost of customization as a result.

Another alternate method for achieving a front bezel design which could be readily modified without creating a full-size metal overlay is to use four (or more) pre-formed metal pieces (without affixed corners) which are then attached to the Front Shell 136, covering the front face (and additionally the side faces if desired) and thereby establishing the primary color and finish of the system. FIG. 22 illustrates the basic design of such a bezel; this strategy would reduce the size of the bezel shipping container when compared to a full-size overlay, but would be about the same weight and cost.

In one embodiment of the present invention, the Front Shell 136 is designed to accommodate a relatively thin overlay which allows for the customization of the visible surface. The overlay would be a commercially available laminate such as those manufactured by Wilsonart International (see Exhibit E). In this way, a thin, light weight, relatively inexpensive finish modification kit can be supplied for field modification, or used to modify finished goods inventory prior to customer shipment. In addition, since the laminates are standard products and available in a wide assortment of finishes, a wider range of finishes can be offered to the display system customer without significantly increasing the cost to support the customization strategy.

FIG. 20 illustrates a bottom view/cross section of one embodiment of the present invention. The Front Shell 196 is typically made of a metal like aluminum, with a radius corner created during the forming process. The Laminate Front 197 and Laminate Side 198 pieces are adhered to the Front Shell 196 and form a 90-degree angle (without a radius) at the corner.

FIG. 21 is a preferred embodiment of the present invention whereby and additional pre-formed Laminate Corner 199 is used to create a radius on the finished corner. Because most laminates have limited cold bending properties, the Laminate Corner 199 would generally be formed using heat at the manufacturing site rather than in the filed, in order to get an appropriate radius.

The present invention addresses the stated deficiencies in the prior art by facilitating a low-cost method for supporting a wide range of customized finishes for the display system, and an economical method for modifying systems already in the field.

To draw the distinction between the prior art in large-format display system bezel and finish designs and the present invention more clearly, the present invention is focused specifically on designing the front bezel to readily accommodate existing laminate materials.

The present invention is therefore novel in its application of large-format display bezel designs, and unique in its capabilities, in that it addresses the stated deficiencies in the prior art.

Another deficiency of large-format display systems representative of prior art arrangements is that the location of the power and other cables does not facilitate flush mounting or are required to protrude out from the sides of the back shell component (see Exhibit 0 specifications). This creates security issues as explained previously, as well as limiting the ability to hide the cables and related wall receptacles from view once the system is installed in its final location. Clearly, a design which facilitates easy access for authorized personnel, but secured (and hid) these components when fully installed would be an improvement to prior art arrangements.

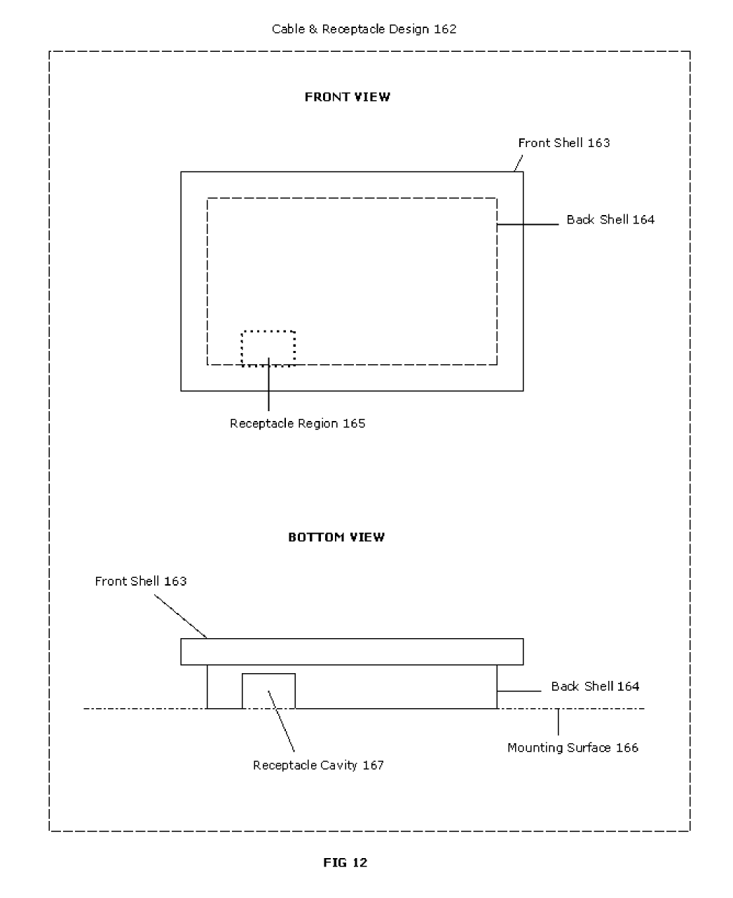

FIG. 12 illustrates the key design elements of a preferred embodiment of the present invention, whereby the power and data receptacles are located behind the Back Shell 164 in the Receptacle Region 165. The Back Shell 164 includes a Receptacle Cavity 167 whereby the receptacles can be accessed from below prior to attaching the Security Collar 156 (FIG. 10). The associated cable connections are designed so that any external cables can be run to the receptacles or through the Mounting Surface 166 in the Receptacle Cavity 167 region. Of course, the exact location of the Receptacle Cavity 167 is not relevant, only that it is positioned inside the perimeter of the Back Shell 163 and facilitates access from one side of the Back Shell 163 when the system is installed onto the mounting bracket.

Using the design strategy outlined above, the location for the system can be provisioned in advance by locating receptacles and cable pass-through holes in the specified area. Once provisioned, the system can be mounted onto the mounting brackets, and then the cable connections can be made. Finally, the Security Collar 156 (FIG. 11) can be attached. Once completed, the receptacles and cables would be hidden from view and only accessible to authorized personnel.

The present invention addresses the stated deficiencies in the prior art and facilitates a method for hiding and securing access to receptacles and cables in flush mounted applications.

To draw the distinction between the prior art in large-format display cabling design systems and the present invention more clearly, the present invention is focused specifically on hiding and securing external cables in a flush-mounted design without increasing the outside dimensions of the Back Shell 164.

The present invention is therefore novel in its application of large-format display external cabling design, and unique in its capabilities, in that it addresses the stated deficiencies in the prior art.

Another deficiency of large-format display systems representative of prior art arrangements is that these systems include ventilation openings to provide airflow for cooling purposes. This allows airborne dirt, grease, and other particulates to enter the system case and settle in on the electronic components and display surfaces. Over time, the accumulation of such material can have a detrimental impact on operating life. For plasma display systems in particular, there is an additional problem of buildup on the glass surfaces of the Display Panel and optical filter, since in all known applications these two surfaces are separated by some amount and open to the internal flow of air and therefore foreign particles. Over time, this buildup causes degradation in the luminosity of the display because the light is being transmitted through a layer of dirt and grime.

An additional problem with the ventilation openings is that they expose the system to failure in high moist environments, or in the case of unattended public applications, intentional or unintentional damage from liquids being pouring into the openings.

Given the sensitivity of the market to these issues, there exists a strong incentive to develop a system which would overcome the stated deficiencies in prior art arrangements.

In a preferred embodiment of the present invention, all ventilation openings are eliminated and the internal heat-producing components are thermally coupled to the Back Shell 164 (FIG. 12). When used in conjunction with the flush-mounting design strategy discussed previously, the wall or stand itself becomes a heat sink which may provide sufficient cooling in some applications. If additional cooling is required, a properly designed heat sink can be inserted between the Back Shell 164 and the mounting surface. This heat sink would be thermally coupled to the Back Shell 164, and could be passive or include supplemental active cooling features if required.

The present invention addresses the stated deficiencies in the prior art and facilitates an alternate cooling method which eliminates ventilation openings and the problems associated with them.

To draw the distinction between the prior art in large-format display thermal design and the present invention more clearly, the present invention is focused specifically on eliminating ventilation openings for this class of device, for which there are no known prior art examples.

The present invention is therefore novel in its application of large-format display cooling design, and unique in its capabilities, in that it addresses the stated deficiencies in the prior art.

One of the greatest practical challenges to deploying and managing a large network of Digital Signage systems is keeping the Total Cost of Ownership (“TCO”) under control. The present invention outlines numerous areas for improvement over prior art in the areas of minimizing site provisioning costs, lowering the initial cost of the hardware, lowering the installation costs of the hardware, lowering the upgrade costs of previously-installed hardware, and lowering the field service costs for the hardware.

Other areas for improvement over prior art exist in the field of advanced monitoring, remote diagnostics, remote failure diagnosis, and advanced failure detection. The ultimate goal for all of these interrelated technologies is to use the “networked intelligent node” characteristics of the VNA architecture to actively monitor the hardware's “vital signs” (individual component status and operating history, as well as system-level operating statistics) so that individual component failures can be detected in advance, remotely diagnosed post-failure, or taken out of the “critical path” by triggering fault-tolerant system contingencies. Most of these hardware monitoring capabilities are ultimately designed to generate more efficient service calls or minimize system down time from failures.

With the exception of the WayFinder42, there are no known examples of large-format VNA systems on the market yet, but it is believed that there are several in development as of the time of this writing. To date, large-format Digital Signage systems have been built using plasma or LCD monitors, external computers, third-party touch sensors (where interactive applications are being used), and other client-side hardware as required. To the extent that remote system monitoring is being used in the Digital Signage industry today, it consists of running third-party PC-based software monitoring tools which report on the status of the PC itself and identify if the Internet connection is operational; these statistics, although helpful, do not include many of the system vital signs which could be made available within the context of a fully self-contained VNA architecture.

Referring to FIG. 2, most of the components of the VNA System 112 (Processor 113, Display Interface 114, Display Panel 115, Touch Components 116, and Other Components 117) include status signals which can be reported back to the Processor 113 (or other local processor responsible for managing the monitoring processes) for logging or real-time capture by the “back-end” system through the Network Interface 119 (“Monitoring Variables”). In addition, some of these components facilitate running certain diagnostics routines to assist in determining the operating condition of the component.

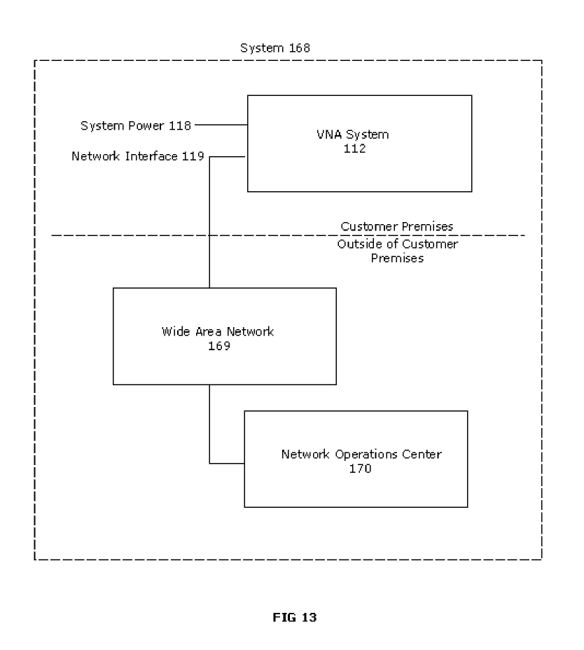

FIG. 13 illustrates a preferred embodiment of the present invention. In it, the Network Operations Center 170 (which is at a different physical location from the customer premises), communicates with the VNA System 112 over a Wide Area Network 169. All of the available Monitoring Variables for System 112 are periodically collected by the Network Operations Center 170 and stored for analysis. The protocol for accessing and collecting the Monitoring Variables can be SOAP or another appropriate protocol. The analysis of the Monitoring Variables by the Network Operations Center 170 computer would include scanning for predetermined threshold values which indicate some component of the system is operating outside acceptable limits or, based on previous failure history, is likely to fail within a specific period of time. Analysis would also include scanning the data for specific variables in the Monitoring Variables set which are designated to indicate some immediate action should be taken; for example, the presence of an alarm indicating that the Security Collar 156 (FIG. 10) had been opened may trigger a cross-reference to the service schedule to determine is a service technician was scheduled, and if not, may trigger a security validation process.

The present invention addresses the stated deficiencies in the prior art and facilitates improving the efficiency of field service calls and system security by utilizing an active remote monitoring method.

To draw the distinction between the prior art in large-format VNA system and the present invention more clearly, the present invention is focused specifically on active monitoring of a remote VNA system, wherein hardware-specific variables are collected by a backend system for additional analysis.

The present invention is therefore novel in its application of large-format VNA monitoring design, and unique in its capabilities, in that it addresses the stated deficiencies in the prior art.

Another area for improvement over prior art exists in the field of remote control of Digital Signage systems. Whether the Digital Signage system is of the type illustrated by FIG. 1 (System 100), a VNA-class system illustrated by FIG. 2 (System 112), or some other variation not shown, there are no known prior art arrangements whereby a Digital Signage system can be remotely controlled during the initial boot sequence of the Processor 101 (FIG. 1), Processor 113 (FIG. 2), or other equivalent system processor. The reason is because in traditional design the remote control process is accomplished entirely through the processor's network interface, which is not enabled until some time later in the boot sequence, after local mouse keyboard and video is active. This is problematic in that during many Operating System (“OS”) and system application updates and changes, the system must be rebooted, during which time remote control systems representative of prior art lose control of (and visibility into) the remote system. As it turns out, it is precisely during the early boot sequence (prior to the network interface becoming active) when problems occur which require controlling the local processor's keyboard and/or mouse in conjunction with viewing the Video Output in order to solve. Additionally, in some preferred modes of operation to troubleshoot or diagnose system problems, the network interface actually needs to be disabled. The present invention addresses these deficiencies in the prior art.

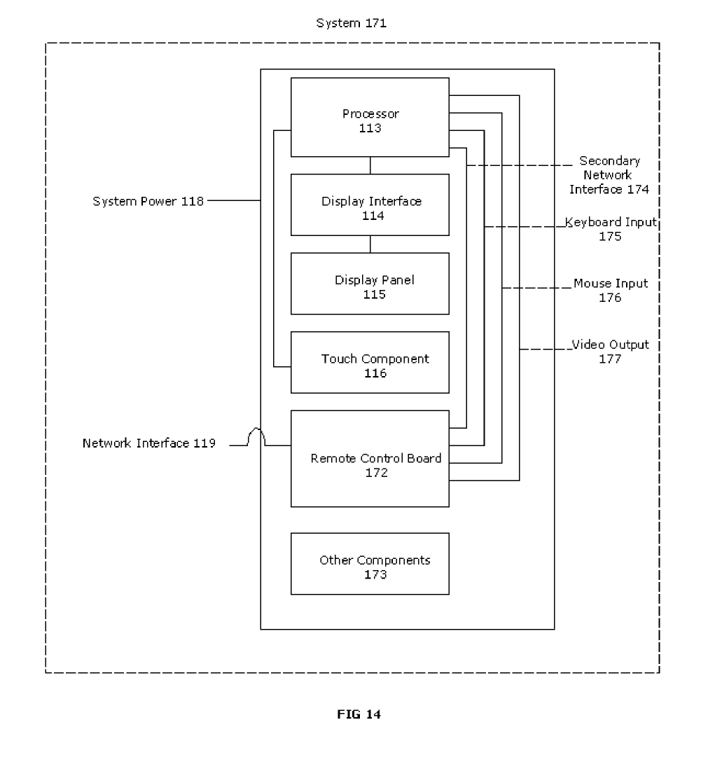

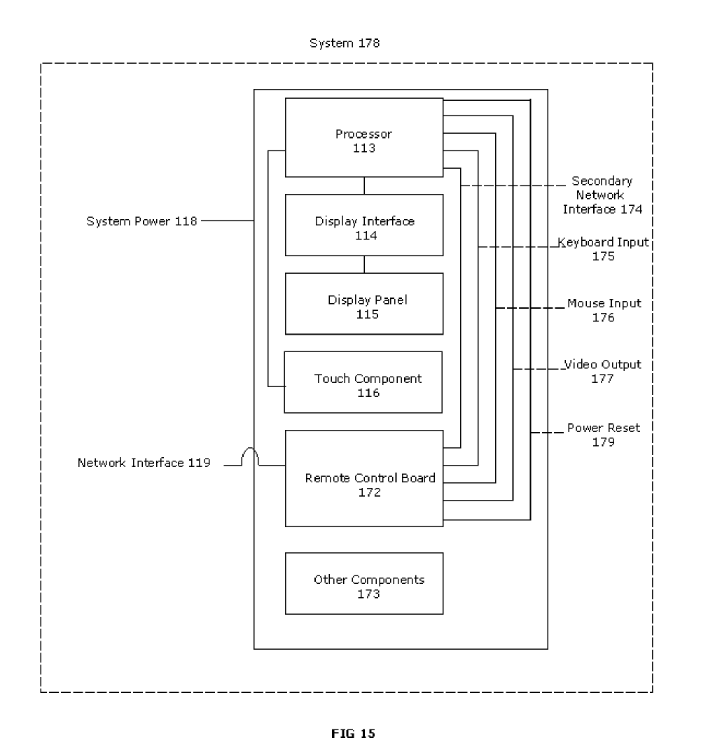

FIG. 14 illustrates a preferred embodiment of the present invention. The System 171 block diagram includes most of the same blocks as the System 112 (FIG. 2), but adds a Remote Control Board 172 which is used as the primary Network Interface 119 connection point (as opposed to the Network Interface 119 being connected to the Processor 113 block in System 112). The Remote Control Board 172 in turn connects to the Processor 113 through a Secondary Network Interface 174, Keyboard Input 175, Mouse Input 176, and Video Output 177 as shown. As a result, the Remote Control Board is able to relay Keyboard, Mouse and Video information between the Operations Center 170 (FIG. 13) and the Processor 113 through the Network Interface 119, which can be accomplished at any time, including the initial boot sequence of the Processor 113 system.

The present invention addresses the stated deficiencies in the prior art and facilitates remote control of the system's main processor during all portions of its boot sequence.

To draw the distinction between the prior art in large-format Digital Signage systems and the present invention more clearly, the present invention is focused specifically on remote control of the system's main processor through the use of additional hardware which has its own network interface and facilitates access to the main processor's keyboard, mouse, and video ports.

The present invention is therefore novel in its application of large-format Digital Signage system design, and unique in its capabilities, in that it addresses the stated deficiencies in the prior art.

Another deficiency in prior art designs has to do with remote power reset capabilities. It is fairly common for the system's OS to become non-responsive to any input in which case the power to the processor board must be turned off, then on again (“power reset”) in order to reboot the system and alleviate the lock-up condition. In this situation, traditional remote control designs would be unable to achieve the power reset because when the system OS is locked up, the network interface is non-functional. FIG. 15 illustrates a preferred embodiment of the present invention, whereby a Power Reset 179 control line is added to the Remote Control Board 172, thereby allowing power reset of the Processor 113 to be achieved even when its OS is locked up.

The present invention addresses the stated deficiencies in the prior art and facilitates remote reset of the system's main processor even when its OS is locked up.

Most Digital Signage systems are deployed using large-format displays in public locations, designed to present images in high visibility, high traffic locations to many consumers simultaneously. In addition, a clear trend in the Digital Signage industry is to use a public Internet content distribution scheme which allows digital data to be delivered over what has become a ubiquitous, cost effective network technology. However, the combination of these two elements, combined with frequent security breaches of systems attached to the Internet, presents a particularly significant business risk for Digital Signage networks. The risk is that an individual will target the delivery of unauthorized pornographic or other sensitive content onto the Digital Signage network; the result could mean the dismantling of the entire Digital Signage network because of the public backlash which could occur from a highly visible incident (imagine a group of children in a large mall being exposed to this kind of content).

Given the fact that even the most highly sensitive systems in the country have not been immune to unauthorized breaches when connected in some way to the Internet, it would seem likely that as Digital Signage networks become more prevalent, a major unauthorized content incident will occur at some point unless additional security precautions are implemented.

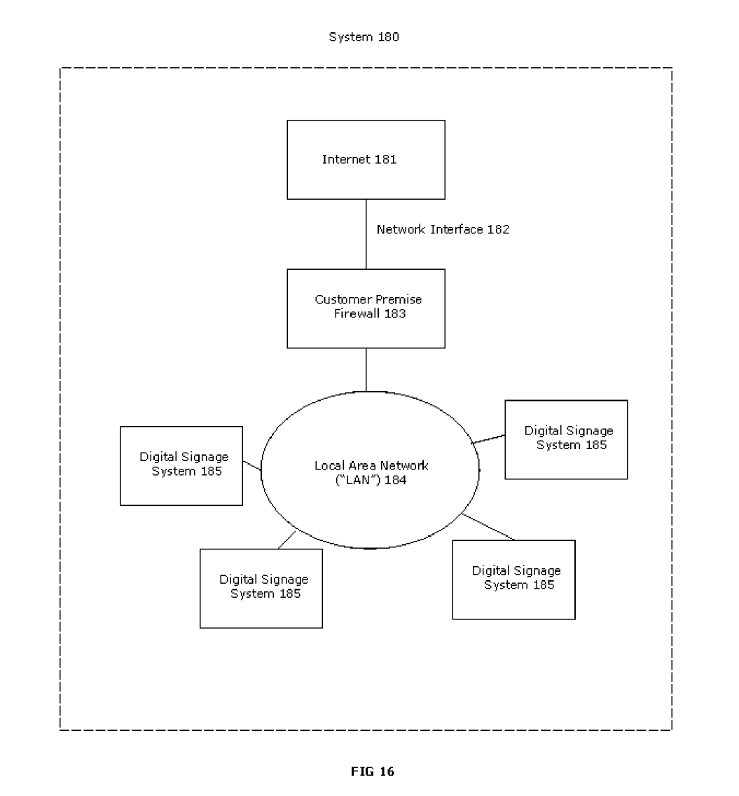

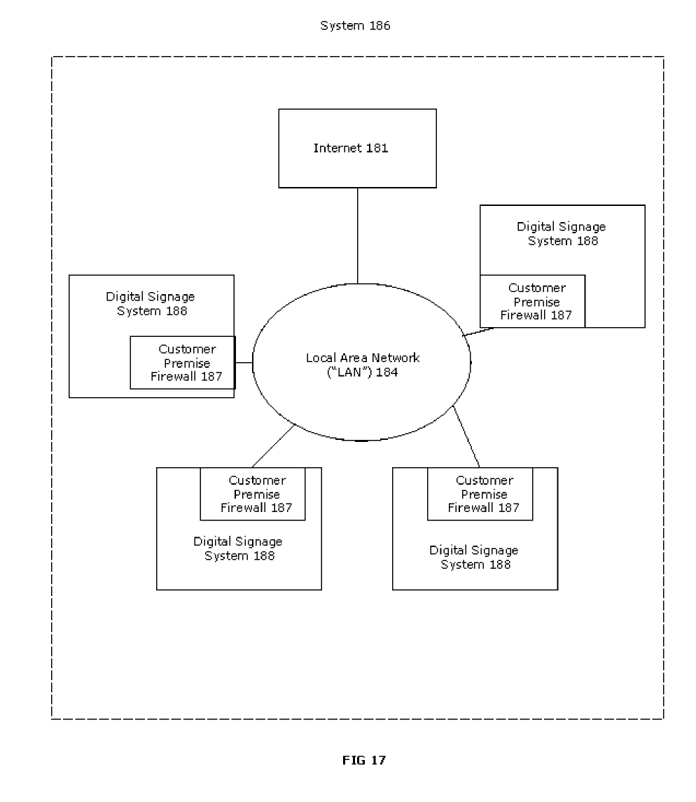

FIG. 16 illustrates the basic components of the network security architecture representative of most traditional Digital Signage systems currently deployed. In it, the Customer Premise Firewall 183 uses the Network Interface 182 as the connection to the Internet 181. As such, all data traffic going into the customer premises must pass through the Customer Premise Firewall 183, which contains the security features typical of hardware firewall equipment (or software firewall applications run on a general purpose computer). Content which has been authenticated by the Customer Premise Firewall 183 is then passed on to the LAN 184 for distribution to one or more Digital Signage Systems 185.

This architecture places most of the burden for security on the Customer Premise Firewall 183, leaving the Digital Signs exposed to access from the another computer connected to the LAN 184 itself. Although other network security features are generally present, the simple fact that the Customer Premise Firewall 183 is commonly used clearly suggests that those other network security features are insufficient on a stand-alone basis.

The content security architecture shown in FIG. 16 was designed to accommodate general purpose computers which can run any combination of available operating systems and software applications, and communicate with any combination of local or remote computers. Because the security system must accommodate all of these combinations and permutations, it is weakened over what could be implemented within a more controlled environment. The present invention utilizes this fact, in conjunction with some unique characteristics of Digital Signage systems, in order to facilitate improved security in this specific application.

FIG. 16 illustrates the basic components of an embodiment of the present invention which facilitates a significant reduction in the exposure of Digital Signage networks to unauthorized content from being displayed. In this architecture, the Customer Premise Firewall 187 is embedded within each Digital Signage System 188 and the Internet 181 is connected directly to the LAN 184 without passing through a firewall. In a preferred embodiment of the present invention, the Customer Premise Firewall 187 is embedded within the VNA System 112 (FIG. 2), behind the Security Collar 156 (FIG. 10).

With this architecture, the Digital Signage System 188 is no longer susceptible to an increased opportunity for breach from a computer attached to the LAN than it would be when connecting to the LAN over the Internet 181.

An additional measure of protection is then gained by recognizing that Digital Signage applications are primarily single-use applications run on general-purpose hardware and operating systems. As such, the OS and applications are generally consistent across the entire network, including the specific configuration for the OS and all applications which reside on any given Digital Signage system. The only variation between Digital Signage systems on the same “Contiguous Network”(meaning, deployed within one customer's facilities running the same set of applications by the same Digital Signage operator), is in the content and temporary file profiles, which tend to vary between different Digital Signs on the network.

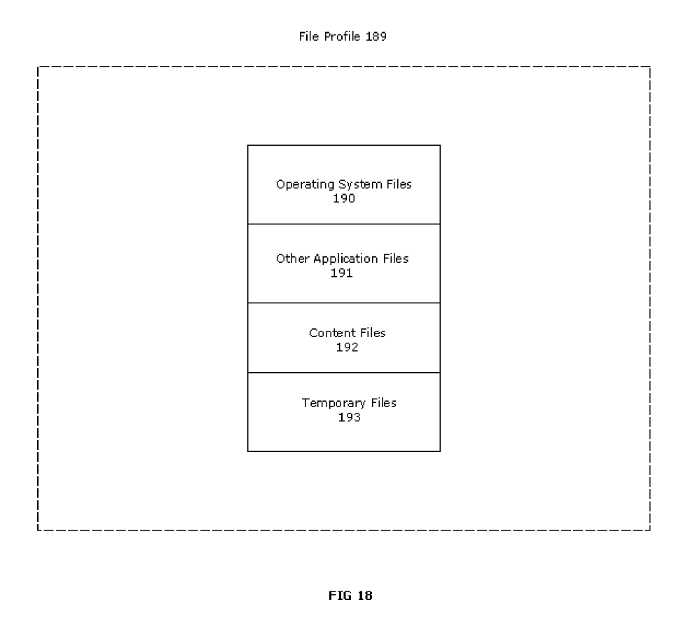

FIG. 18 summarizes these four types of files stored on the local drive of the Digital Signage System for executing on the main system processor, which fall into one of four general categories: Operating System Files 190, Other Application Files 191, Content Files 192, and Temporary Files 193 (which are generated by the OS during program execution.

In a preferred embodiment of the present invention, the Operating System Files 190 and Other Application Files 191 are consistent across the Contiguous Digital Signage Network. These two groups of files are then isolated and a check sum (or other available mechanism for efficiently comparing two sets of digital data for equivalence) is run on them to establish the baseline for equivalence. Once this is done, any other Digital Sign on the Contiguous Network must always generate an identical check sum or a potential unauthorized modification could have occurred.

Of course when it comes to security, the system is only as good as its weakest link. Establishing the integrity of the Operating System Files 190 and Other Application Files 191 is of little use unless the other file types are also secured.

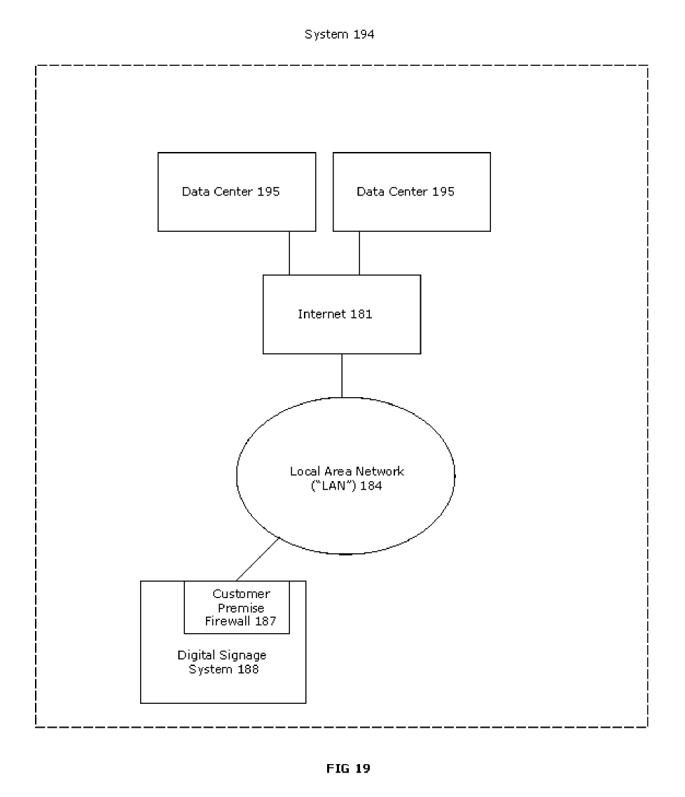

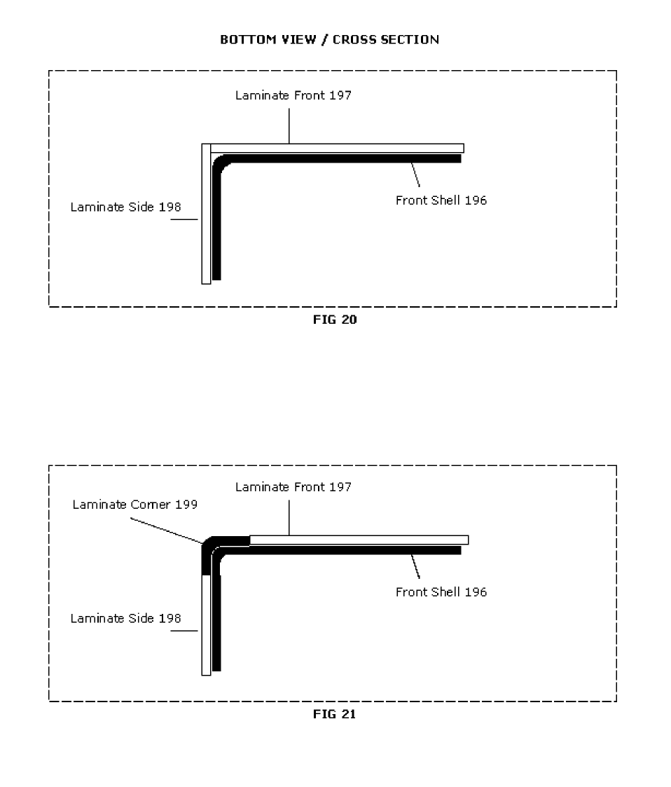

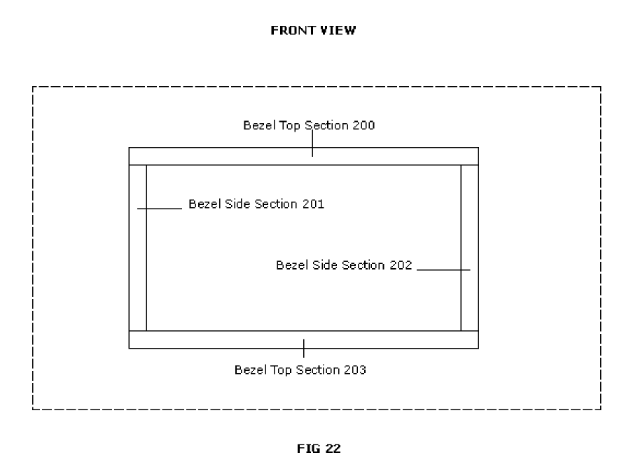

FIG. 19 illustrates a further enhancement of the present invention, wherein Data Centers 190 and 191 are from a finite group of pre-defined locations which are authorized to communicate with the Digital Signage systems. Because of the fact that all Internet data traffic is IP-based and the network is very cognitive of duplicate IP addresses, establishing the origin of the content coming from Data Centers 190 and 191 is straightforward for someone with ordinary skill in the art. In a preferred embodiment of the present invention, the Customer Premise Firewall 187 is configured to ignore all data traffic not coming from one of these authorized Data Center locations. In this way, the Content Files 192 (FIG. 18) can be validated as being from an authentic source prior to being transferred into the Digital Signage systems.

Further security of the Content Files 192 can be achieved by utilizing Virtual Private Network (“VPN”), data encryption, and secure key technologies which are commercially available and understood by those with ordinary skill in the art. These additional features of the security system would provide protection against an unauthorized computer on the network fraudulently representing itself as an authorized Data Center and sending unauthorized content to the Digital Signage systems.

If the Operating System Files 190 and Other Application Files 191 are secured from unauthorized changes as described above and the Content Files 192 are the only means for adding new files to the system (even modified Application Files 191 and updated Operating System Files 190 would be sent to the Digital Signage systems as secure Content Files 192, along with a new checksum), then the Temporary Files 193 would only be generated by legitimate code running on the system. If needed, additional precautions could be implemented with respect to these files to validate their legitimacy or limit their impact if they were in fact from an unauthorized source.

The present invention addresses the stated deficiencies in the prior art and facilitates a substantially improved content security system.

To draw the distinction between the prior art in Digital Signage systems and the present invention more clearly, the present invention is focused specifically on using a security architecture which utilizes a common operating system and application configuration within a “contiguous” Digital Signage network with mechanisms to validate equivalence of their associated files, in conjunction with secure content updates being sent only from a finite group of authorized data centers and mechanisms for validating the integrity of these files before they are accepted by the Digital Signage system.

The present invention is therefore novel in its application of Digital Signage content security design, and unique in its capabilities, in that it addresses the stated deficiencies in the prior art.

1. A large-format display system, the system comprising:
a thin, self-contained display system including a housing, the housing characterized by a length, width and depth dimension, the display system further comprising:
an electronic flat panel display screen contained within said housing, the display screen having an active viewing area larger than 29 inches diagonal;
a mounting system for mounting said housing directly onto a wall or secondary mounting surface such as a floor stand or ceiling mount;
and a computer module with electrical interface to said display system, the electrical interface not requiring cables to be run external to said housing, the computer module further comprising:
a mechanical interface whereby said computer module may be removed or added to said display system without opening up said housing, the computer module further comprising:
a data communications interface to a Local Area Network or Wide Area Network.

2. The system of claim 1, wherein said computer module further comprises a mechanical interface whereby the computer module can be removed from or added to said display system while said housing is secured to said mounting system.

3. The system of claim 1, wherein said display system protrudes less than 4.0 inches from the wall or secondary mounting surface while said housing is mounted onto said mounting system.

4. The system of claim 1, wherein said mounting system includes ICBO-approved mounting hardware and is designed to meet Uniform Building Code earthquake safety requirements for U.S. commercial facilities.

5. The system of claim 1, wherein said display system includes a security system which limits unauthorized access to the display system when secured to said mounting system, the security system further comprising:
means for restricting access to all cables external to said housing;
means for restricting access to all buttons and switches accessible from outside said housing;
and means for restricting access to said mounting system release hardware which facilitates removal of said housing from the mounting system.

6. The system of claim 5, wherein said local security feature uses a screw to gain access.

7. The system of claim 5, wherein said local security feature uses a key gain access.

8. The system of claim 5, wherein said local security includes a sensor which allows said computer module to recognize when local security access has occurred.

9. The system of claim 8, wherein said display system includes a camera system which communicates with said computer module, said computer module further comprising application software which sends remote notification information when local security access has occurred, said application software also facilitating substantially real-time viewing of camera images from a remote location.

10. The system of claim 1, wherein said display system further comprises a touch sensing system capable of recognizing touch input in the active viewing area of the front surface of the display system.

11. The system of claim 10, wherein said touch sensing electronics is contained within said housing, behind the housing bezel component.

12. The system of claim 11, wherein said touch sensing system can be removed from or added to said display system by removing said housing bezel, such removal being possible without removing the housing from said mounting system.

13. The system of claim 1, the system further comprising a remote management module capable of controlling said computer module's keyboard and mouse inputs while viewing said computer module's video output, such remote management occurring through a data communications network interface.

14. The system of claim 13, wherein said remote management module further comprises a mechanical interface whereby said remote management module may be removed or added to said display system without opening up said housing.

15. The system of claim 1, wherein said electronic flat panel display screen is digital and said computer module interfaces to display screen without conversion to an analog signal format.

16. The system of claim 1, the system further comprising a digital camera system with electrical interface to said computer module.

17. The system of claim 1, wherein said housing contains no air ventilation holes.

18. The system of claim 1, wherein said display system contains no electro-mechanical cooling systems.

19. The system of claim 18, wherein said mounting system further supports portrait orientation, and a secondary mounting system supports landscape orientation, wherein neither of said mounting systems require the addition of any electro-mechanical cooling systems.
